(19) United States
(12) Patent Application Publication
(10) Pub. No.: US 2003/0179736 A1
(43) Pub. Date: Sep. 25, 2003

(54) Programmable monitoring circuit

(75) Inventors: Oz Weisler, Zoran (IL); Tzfenia Talisher, Zichron Yaakov (IL); Israel Ben-Yeda, Raanana (IL)

Correspondence Address: LEFFERT JAY & POLGLAZE, P.A., P.O. BOX 581009, MINNEAPOLIS, MN, 55458-1009, US

(73) Assignee: ADC Telecommunications Israel Ltd.

(21) Appl. No.: 10/103,500

(22) Filed: Mar. 21, 2002

(51) Int. Cl. H04Q 7/28

(52) U.S. Cl. 370/341

(57) ABSTRACT

A monitoring circuit is provided. The monitoring circuit includes a bus interface that is adapted to be coupled to a bus for monitoring signals on the bus. The monitoring circuit also includes a programmable data capture circuit, coupled to the bus interface, that is adapted to be programmed to selectively capture data from the bus interface based on at least one criteria. The monitoring circuit further includes a memory, coupled to the programmable data capture circuit, that stores data provided by the programmable data capture circuit. A user interface is also coupled to the programmable data capture circuit. The user interface provides access to the programmable data capture circuit for programming the at least one criteria for capturing data. A controller is coupled to the user interface and the programmable data capture circuit to control the programming and operation of the programmable data capture circuit.

### TECHNICAL FIELD

The present invention relates generally to the field of monitoring circuits and, in particular, to a programmable monitoring circuit for automatically monitoring a communication bus.

### BACKGROUND

Many telephone companies use digital loop carriers to increase the capacity of their local telephone exchanges. Digital loop carriers typically include a number of line cards, e.g. ISDN cards, coupled to modems, telephones, and the like.

Many line cards have digital transceivers for digital signals and analog input/output ports. These line cards typically use ICs (codecs) to convert analog signals into digital signals and digital signals into analog signals. Further, these line cards typically include a line card controller that provides an interface to a microprocessor that controls the card. A communication bus, e.g. the IOM 2, is often used to provide a communication path between the digital transceivers and the line card controller and between the codecs and the line card controller. In turn, the line card controller is often connected to the backbone of a digital switch, such as a pulse code modulation switch.

Typical communications buses time multiplex data and provide control and status information for the line card. Because of this, communication buses are often monitored to detect problems with the line card. Normally, a technician monitors a communication bus by attaching an oscilloscope or other appropriate monitoring equipment to the communication bus. With the monitoring equipment in place, the technician then either attempts to re-create the problem or simply wait for the problem to occur. Unfortunately, many of the problems are intermittent and having a technician wait for a problem to occur may not be practical. For example, several technicians may be scheduled to monitor a communication bus around the clock for days at a time to solve an intermittent problem, thus wasting numerous technician-hours.

For the reasons stated above, and for other reasons stated below which will become apparent to those skilled in the art upon reading and understanding the present specification, there is a need in the art for less labor intensive techniques for identifying problems in telecommunications equipment.

### SUMMARY

The above-mentioned problems with monitoring communication buses and other problems are addressed by embodiments of the present invention and will be understood by reading and studying the following specification. Embodiments of the present invention provide a monitor that automatically monitors a communication bus in the absence of a user. In some embodiments, the monitoring circuit records data from the bus for later analysis by a technician. In some embodiments, the monitoring circuit is programmable and is triggered to record data from the communication bus based on user-defined parameters. Further, in other embodiments, the monitoring circuit is accessible remotely, e.g., gathered data is downloaded over the Internet or other appropriate network.

More particularly, in one embodiment, a monitoring circuit is provided. The monitoring circuit includes a bus interface that is adapted to be coupled to a bus for monitoring signals on the bus. The monitoring circuit also includes a programmable data capture circuit, coupled to the bus interface, that is adapted to be programmed to selectively capture data from the bus interface based on at least one criteria. The monitoring circuit further includes a memory, coupled to the programmable data capture circuit, that stores data provided by the programmable data capture circuit. A user interface is also coupled to the programmable data capture circuit. The user interface provides access to the programmable data capture circuit for programming the at least one criteria for capturing data. A controller is coupled to the user interface and the programmable data capture circuit to control the programming and operation of the programmable data capture circuit.

### BRIEF DESCRIPTION OF THE DRAWINGS

FIG. 1 is a block diagram of an embodiment of a monitor of the present invention.

FIG. 2 is a block diagram of another embodiment of a monitoring circuit of the present invention.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

Embodiments of the present invention provide a mechanism for identifying and solving problems with the operation of telecommunications equipment. Advantageously, the embodiments shown and described provide a diagnostic mechanism that gathers data with reduced user interaction compared to existing techniques. This is accomplished by an automated system that captures data indicative of the operation of a system under test. The embodiments are programmable in that the trigger criteria used to determine what data to collect is set by the user. Once the trigger is set and the monitoring circuit is in place, no further user intervention is required until data is to be down loaded for analysis. In this manner, intermittent problems with a system under test can be identified without requiring the technician to stay on site until the problem reoccurs thereby saving time and money in diagnosing and solving problems.

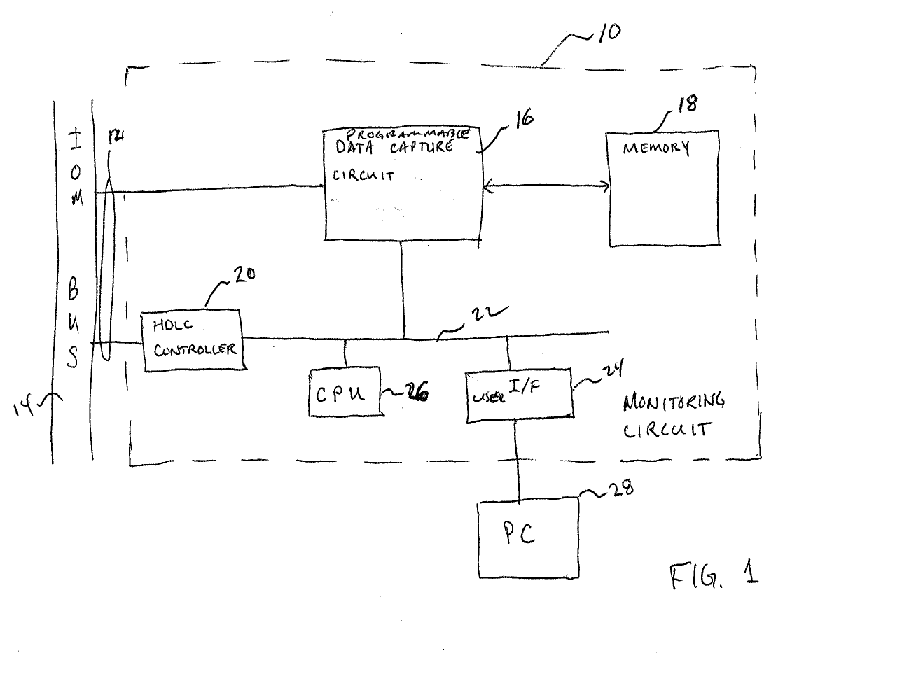

FIG. 1 is a block diagram of one embodiment of a monitoring circuit, indicated generally at 10 according to the teachings of the present invention. Monitoring circuit 10 includes interface 12 that is adapted to connect to bus 14 in a system under test. Through interface 12, monitoring circuit 10 gathers data from the system under test. In this embodiment, bus 14 is shown as an ISDN Oriented Modular Interface, Revision 2 (IOM-2) bus. It is understood that other busses can be monitored in other systems so long as a trigger criteria can be established for beginning to record data off from bus 14.

Monitoring circuit 10 includes programmable data capture circuit 16. In one embodiment, circuit 16 is implemented in a field programmable gate array (FPGA). Circuit 16 is programmed with at least one criterion for capturing data from bus 14. For example, circuit 16 is programmed to recognize an ISDN conversation type such as activation, deactivation or other aspect of an ISDN call. In one embodiment, this is accomplished by decoding signals on the command/indicate (C/I) channel of an IOM-2 bus. Once programmed and installed, circuit 16 captures data from bus 14 on the occurrence of the selected trigger event. The captured data is stored in memory 18.

Monitoring circuit 10 also includes HDLC controller 20. HDLC controller 20 is coupled to bus 14 through interface 12. HDLC controller 20 is also coupled to circuit 16 through bus 22. Advantageously, HDLC controller 20 allows monitoring circuit 10 to analyze portions of, for example, an ISDN channel on bus 14. Thus, in some embodiments, HDLC controller 20 is also used to capture data, e.g., D channel data, for storage in memory 18.

Monitoring circuit 10 further includes user interface (I/F) 24 and central processing unit (CPU) 26. User interface 24 and CPU 26 are coupled to bus 22. User interface 24 allows access to monitoring circuit 10. Through interface 24, a user reads data from memory 18. This data is either downloaded to a computer, e.g., computer 28 through a direct connection to interface 24 or over a network, e.g., the Internet. Further, interface 24 provides a mechanism for programming the programmable features of circuit 16, e.g., data capture criteria are entered through interface 24. Typically, CPU 26 receives the criteria from computer 28 and passes the criteria to circuit 16 and/or HDLC controller 20.

In operation, monitoring circuit 10 monitors the operation of a system under test by monitoring signals on bus 14. Monitoring circuit 10 operates with reduced user intervention by automatically capturing data based on at least one programmed criterion. The at least one programmed criterion used to capture data is programmed into circuit 16 through user interface 24 and CPU 26. When the selected criterion occurs, data capture circuit 16 and/or HDLC controller 20 pass data from bus 14 to memory 18. Later, the data is read out from memory 18 through user interface 24 either locally or over a remote connection. The data is then used to identify and solve problems with the system under test.

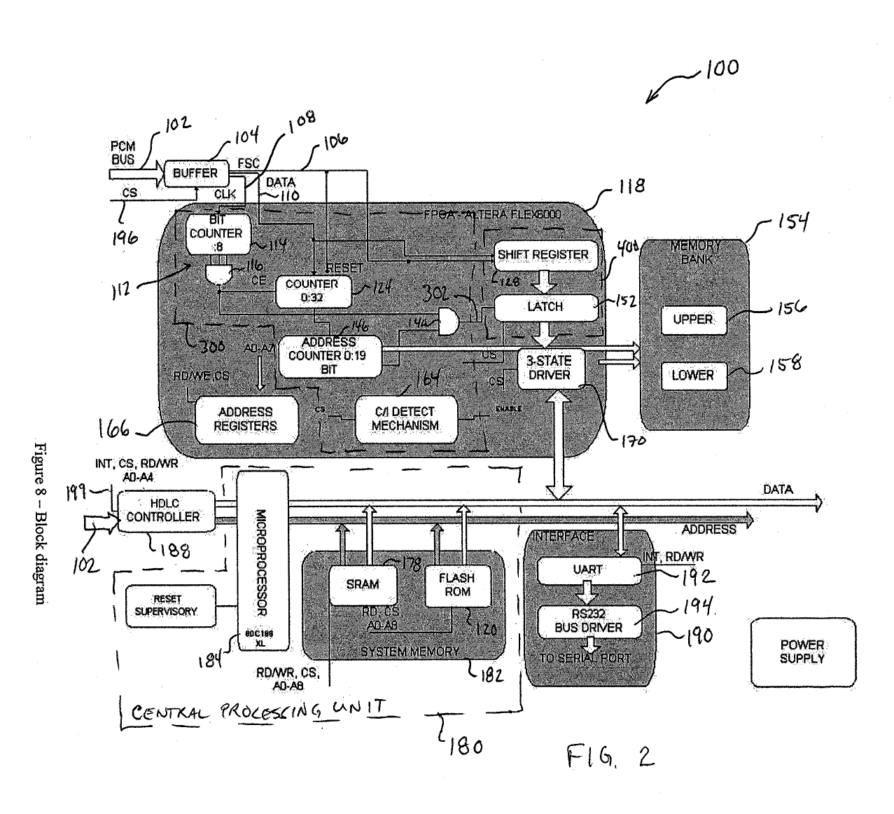

FIG. 2 is a block diagram of another embodiment of a monitoring circuit, indicated generally at 100, according to the teachings of the present invention. Monitoring circuit 100 automatically monitors a communication bus 102 based on a set of programmed user instructions. In one embodiment, communication bus 102 is used in a line card of the type used in digital loop carriers. In another embodiment, communication bus 102 is a line-card version of an IOM-2 bus.

Monitoring circuit 100 includes a buffer 104, a data capture circuit 118, a memory bank 154, a central processing unit 180, an HDLC controller 188, such as a Siemens SAB 82525, and an interface 190. Buffer 104 connects monitoring circuit 100 to communication bus 102. Buffer 104 selectively receives a control signal CS 196 from central processing unit 180 based on user instructions programmed in central processing unit 180. Upon receiving control signal CS 196, buffer 104 transmits data signal 110 from communication bus 102 to capture circuit 118. Capture circuit 118 selects a portion of data signal 110 and stores the selected portion of data signal 110 in memory bank 154 based on user instructions programmed in central processing unit 180. HDLC controller 188 is also connected to communication bus 102 and selectively receives control signal CS 199 from central processing unit 180 based on user instructions programmed in central processing unit 180. Upon receiving control signal CS 199, HDLC controller 188, in one embodiment, decodes IDSN D-channel data and stores the decoded IDSN D-channel data in memory bank 154.

Interface 190, in one embodiment, provides a communication link between a computer and data capture circuit 118, central processing unit 180, and HDLC controller 188. Interface 190 enables the user to control monitoring circuit 100 directly using a computer, enables the output of data from monitoring circuit 100 to a computer, and enables the user to enter commands into central processing unit 180 using a computer. In one embodiment, interface 190 includes a UART (universal asynchronous receiver and transmitter) 192, such as Exar's ST16C550, and an RS232 bus driver 194.

Central processing unit 180 is programmed by the user to automatically control monitoring circuit 100. Thus, the user need not be present for monitoring circuit 100 to monitor communication bus 102. Central processing unit 180 automatically transmits control signal CS 196 to buffer 102 and control signal CS 199 to HDLC controller 188. Central processing unit 180 also tells capture circuit 118 what portion of data signal 110 to select and store in memory bank 154.

Central processing unit 180 includes a system memory 182 that includes a flash ROM 120 and an SRAM 178 and a microprocessor 184, such as an Intel 80C188. In one embodiment, central processing unit 180 has a reset supervisory 186 for monitoring microprocessor 184. Flash ROM 120 is programmed to contain all of the instructions for controlling monitoring circuit 100.

Capture circuit 118 includes a timing circuit 300 and a capture mechanism 400. Timing circuit 300 and capture mechanism 400 receive data signal 110 from buffer 104. Timing circuit 300 divides data signal 110 into time slots and compares the data in each time slot to a user instruction programmed into timing circuit 110 via flash ROM 120. If the data of a time slot fits the criteria of the user instruction, timing circuit 300 sends a timing signal 302 to capture mechanism 400 and allocates a location in memory bank 154 for the time slot of data signal 110. Upon receiving timing signal 302, capture mechanism 400 stores the time slot of data signal 110 at the allocated location in memory bank 154.

More specifically, buffer 104 receives control signal CS 196 and transmits a frame synchronization clock (FSC) signal 106, a data clock signal (DCL) 108, and data signal 110 from communication bus 102 according to instructions programmed by the user into flash ROM 120.

In one embodiment, the frequency of data clock signal 108 is twice the frequency of data signal 110. In embodiments where communication bus 102 is a line-card version of an IOM-2 bus, data clock signal 108 is 4.096 MHz; the data rate is 2.048 Mbits/s; frame synchronization clock signal 106 is 8 kHz; and data signal 110 includes upstream and/or downstream signals. In this embodiment, each of the upstream and downstream signals of data signal 110 is divided into frames transmitted at 8 kHz. Each frame includes eight sub-frames, with each sub-frame including four one-byte-long time slots so that each frame includes 32 time slots. In another embodiment, some of the eight sub-frames contain ISDN D-channel data.

Timing circuit 300, in one embodiment, includes byte counter 112. Byte counter 112 receives data clock signal 108 from buffer 104. Byte counter 112 includes bit counter 114 and gate 116. An output of byte counter 112 is connected to an input of a time-slot counter 124 and to an input of gate 140. Time-slot counter 124 receives frame synchronization clock signal 106 and data signal 110. An output port of time-slot counter 124 is connected to an input of an address counter 146, which in one embodiment is 0 (zero) to 19 bits. An output of address counter 146 is connected to an input of gate 140. An output of gate 140 outputs timing signal 302. Timing circuit 300, in one embodiment, also includes C/I (command/indicate) detect mechanism 164. In another embodiment, C/I detect mechanism 164 includes instructions as to which time slots should be captured by data capture circuit 118. These instructions are programmed into C/I detect mechanism 164 via flash ROM 120.

C/I detection mechanism 164 detects signals on the C/I channel of the IOM bus. The C/I channel is the message channel between the components attached to the bus. Thus, C/I messages provide a trigger for determining when to begin to store data from bus 102. In one embodiment, C/I detect mechanism 164 is used to synchronize to the frame data when needed.

The output of byte counter 112 is transmitted to time-slot counter 124 and gate 140. The output of byte counter 112 advances time-slot counter 124. This mechanism allows data capture circuit 118 to select a specific frame of data from communication bus 102.

Address counter 146 allocates a location in memory bank 154 for the one-byte-long time slot of data signal 110. Address counter 146 also specifies the address of the allocated location in memory bank 154 in address registers 166 as an eight-bit address (e.g., A0-A7). Subsequently, gate 140 transmits timing signal 302 to capture mechanism 400. If the one-byte-long time slot of data signal 110 does not fit the criteria of the user instruction, address counter 146 does not advance; a signal is not transmitted to gate 140; gate 140 does not transmit timing signal 302 to capture mechanism 400; and address counter 146 does not allocate a location in memory bank 154.

Frame synchronization clock signal 106 is received at time-slot counter 124 to reset time-slot counter 124. In embodiments where communication bus 102 is an IOM-2 bus, frame synchronization clock signal 106 resets time-slot counter 122 after 32 time slots.

Capture mechanism 400 in one embodiment includes shift register 128 and latch 152. Shift register 128 receives synchronization clock signal 106 and data signal 1110. In one embodiment, data signal 110 contains serial data; and shift register 128 outputs the serial data of data signal 110 as parallel data. Latch 152 is connected to gate 140 for receiving timing signal 302. Latch 152 is connected to shift register 128 for receiving parallel data from shift register 128.

Upon receiving timing signal 302, latch 152 latches a one-byte-long time slot of the data signal 110 received at shift register 128 into the location in memory bank 154 allocated by address counter 146. If latch 152 does not receive timing signal 302 no data is latched into memory 154.

Memory bank 154, in one embodiment, includes upper memory bank 156 and lower memory bank 158. Upper and lower memory banks 156 and 158 respectively receive data from latch 152. In another embodiment, upstream and downstream signals of an IOM-2 bus operating in the line-card mode are respectively input into in upper and lower memory banks 156 and 158.

In one embodiment, data capture circuit 118 is a programmable logic device, such as a field programmable gate array, e.g., the Altera FLEX 6000. In this embodiment, timing circuit 300, capture mechanism 400, address registers 166, and a three-state driver 170 are programmed into data capture circuit 118 using appropriate software, e.g., Altera's MAX PLUS, burned into flash ROM 120.

Three-state driver 170 has an input that receives a control signal CS 204 automatically from microprocessor 184, according to user instructions programmed in flash ROM 120. In another embodiment, the user generates control signal CS 204 directly using a PC connected to RS232 bus driver 194. In one embodiment, when control signal CS 204 is received at three-state driver 170, three-state driver 170 operates as an input device. When control signal CS 204 is not received at three-state driver 170, three-state driver 170 operates as an output device. The frequency at which three-state driver receives control signal CS 204 is, in one embodiment, programmed in flash ROM 120. In another embodiment, this frequency is controlled directly by the user from a PC.

When operating as an output device, three-state driver 170 transfers data from memory bank 154 to SRAM 178 for analysis and/or output to a PC via interface 190. In one embodiment, the data is analyzed by comparing the data to normal operating data for communication bus 102. The results of the analysis are saved on SRAM 178 for output via interface 190. When operating as an input device, three-state driver 170 transfers programming instructions from flash ROM 120 to capture circuit 118 to program capture circuit 118. For example, instructions are programmed into C/I detect mechanism 164 in this way.

HDLC controller 188 receives control signal CS 199 from microprocessor 184. In one embodiment, the user generates control signal CS 199 directly using a PC connected to RS232 bus driver 194. In another embodiment, HDLC controller 188 reads ISDN D-channel data that has been stored in memory bank 154 and sent to SRAM 178 by three-state driver 170 off SRAM 178 via address bus 200. HDLC controller 188 decodes this ISDN D-channel data and sends the ISDN D-channel data to interface 190.

### CONCLUSION

Embodiments of the present invention have been described. The embodiments provide a monitor for automatically monitoring a communication bus in the absence of a user.

Although specific embodiments have been illustrated and described in this specification, it will be appreciated by those of ordinary skill in the art that any arrangement that is calculated to achieve the same purpose may be substituted for the specific embodiment shown.

What is claimed is:

1. A monitoring circuit, comprising:
a bus interface, adapted to be coupled to a bus for monitoring signals on the bus;
a programmable data capture circuit, coupled to the bus interface, that is adapted to be programmed to selectively capture data from the bus interface based on at least one criteria;
a memory, coupled to the programmable data capture circuit, that stores data provided by the programmable data capture circuit;
a user interface, coupled to the programmable data capture circuit, wherein the user interface provides access to the programmable data capture circuit for programming the at least one criteria for capturing data; and
a controller, coupled to the user interface and the programmable data capture circuit, that controls the programming and operation of the programmable data capture circuit.

2. The monitoring circuit of claim 1, wherein the bus interface comprises an interface to an IOM-2 bus.

3. The monitoring circuit of claim 1, wherein the programmable data capture circuit includes a timing circuit that programmably selects data from time slots on the bus.

4. The monitoring circuit of claim 1, wherein the user-interface comprises an interface for a computer.

5. The monitoring circuit of claim 1, wherein the user interface comprises a UART and an RS232 bus driver.

6. The monitoring circuit of claim 1, and further including an HDLC controller coupled to the bus, the HDLC controller adapted to capture data from the bus for storage in the memory.

7. A method for monitoring a bus, the method comprising:
establishing at least one criteria for capturing data;
programming a data capture circuit based on the established at least one criteria;
detecting an event with the programmed data capture circuit based on the criteria;
capturing data from the bus based on the detected event;
retrieving the captured data; and
analyzing the retrieved data.

8. The method of claim 7, wherein programming a data capture circuit comprises programming a data capture circuit on a field programmable gate array.

9. The method of claim 7, wherein detecting an event comprises detecting at least one of a call activation and a call deactivation.

10. The method of claim 7, wherein capturing data comprises capturing data from time slots in an IOM-2 bus.

11. The method of claim 7, wherein capturing data comprises capturing ISDN data.

12. The method of claim 7, and further capturing data with an HDLC controller.

13. The method of claim 7, wherein retrieving data comprises retrieving data over a network connection.

14. The method of claim 7, wherein retrieving data comprises retrieving data over the Internet.

15. The method of claim 7, wherein establishing at least one criteria comprises establishing a trigger event.

16. The method of claim 15, wherein establishing the trigger event comprises selecting an ISDN call event as a trigger.

17. A monitoring circuit comprising:
a central processing unit;
a buffer adapted to selectively receive a first control signal from the central processing unit according to a first set of user instructions programmed in the central processing unit, the buffer further adapted to receive and transmit a data signal upon receiving the first control signal;
a memory bank; and
a capture circuit connectable to the buffer for receiving the transmitted data signal, the capture circuit adapted to store a portion of the transmitted data signal in the memory bank based on a second set of user instructions programmed into the central processing unit.

18. The monitoring circuit of claim 17, wherein the capture circuit comprises a timing circuit and a capture mechanism.

19. The monitoring circuit of claim 17, and further comprising an HDLC controller adapted to selectively receive a second control signal from the central processing unit according to a third set of user instructions programmed in the central processing unit, the HDLC controller further adapted to receive, decode, and store a portion of the data signal, independently of the buffer, in the memory bank upon receiving the second control signal.

20. The monitoring circuit of claim 17, and further comprising an interface adapted to provide a communication link between the capture circuit and a device external to the monitor.

21. The monitoring circuit of claim 17, wherein the capture circuit is a field programmable gate array.

22. A monitoring circuit comprising:
a central processing unit;
a buffer adapted to receive a first control signal from the central processing unit according to a first set of user instructions programmed in the central processing unit, the buffer further adapted to receive and transmit a data signal upon receiving the first control signal;
a timing circuit adapted to transmit a timing signal based on a second set of user instructions programmed in the central processing unit;
a memory bank; and
a capture mechanism connectable to the buffer for receiving the transmitted data signal, the capture mechanism further connectable to the timing circuit for receiving the transmitted timing signal, the capture mechanism adapted to store a portion of the data signal in the memory bank upon receiving the transmitted timing signal.

23. The monitor of claim 22, and further comprising an HDLC controller adapted to selectively receive a second control signal from the central processing unit according to a third set of user instructions programmed in the central processing unit, the HDLC controller further adapted to receive, decode, and store a portion of the data signal, independently of the buffer, in the memory bank upon receiving the second control signal.

24. The monitor of claim 22, wherein the capture mechanism comprises a shift register.

25. The monitor of claim 24, wherein the capture mechanism comprises a latch connected to the shift register.

26. The monitor of claim 22, and further comprising an interface adapted to provide a communication link between the capture circuit and a device external to the monitor.

27. A monitoring circuit, comprising:
a bus interface, adapted to be coupled to a bus for monitoring signals on the bus;
a programmable data capture circuit, coupled to the bus interface, that is adapted to be programmed to selectively capture data from the bus interface based on at least one criteria;
a memory, coupled to the programmable data capture circuit, that stores data provided by the programmable data capture circuit; and
a user interface, coupled to the programmable data capture circuit, wherein the user interface provides access to the programmable data capture circuit for programming the at least one criteria for capturing data and for downloading captured data.
